(19) United States
(12) Patent Application Publication
(10) Pub. No.: US 2024/0359075 A1
(43) Pub. Date: Oct. 31, 2024

(54) Ultrasonic Golf Club Cleaning Device

(71) Applicant: Connor McLaughlin, Killingworth, CT (US)

(72) Inventor: Connor McLaughlin, Killingworth, CT (US)

(21) Appl. No.: 18/646,825

(22) Filed: Apr. 26, 2024

Related U.S. Application Data
(60) Provisional application No. 63/461,949, filed on Apr. 26, 2023.

(51) Int. Cl. A63B 57/60; A63B 47/04; B08B 3/12

(52) U.S. Cl. CPC A63B 57/60; B08B 3/12; A63B 47/04

(57) ABSTRACT

An ultrasonic golf club cleaning device is provided comprised of a body with an ultrasonic cleaning element that cleans golf clubs and balls. More specifically, the body includes an interior space to accommodate a pan and/or a basket, the former for clubs and the latter for balls, which can be filled with a cleaning solution to remove dirt when the ultrasonic element is activated. The device is characterized by its adaptability to different shapes and sizes of golf club heads through the angled bottom edge of the pan and the inclusion of clips to secure the clubs in an upright position. Additionally, the device features a battery-powered ultrasonic element that can be heated, offering multiple cleaning modes adjustable via a power button and a mode selection button, and an indicator light for operational status.

### CROSS-REFERENCE TO RELATED APPLICATION

The present application claims priority to, and the benefit of, U.S. Provisional Application No. 63/461,949, which was filed on Apr. 26, 2023, and is incorporated herein by reference in its entirety.

### FIELD OF THE INVENTION

The present invention relates generally to the field of golf equipment cleaning devices. More specifically, the present invention relates to an ultrasonic golf club cleaning device that can be used to clean golf clubs and golf balls. Accordingly, the present disclosure makes specific reference thereto. Nonetheless, it is to be appreciated that aspects of the present invention are also equally applicable to other like applications, devices, and methods of manufacture.

### BACKGROUND

Maintaining the cleanliness of golf clubs and golf balls is not only a crucial aspect of golf but also a significant challenge for many enthusiasts. The process of keeping these items in pristine condition can be daunting, often demanding a considerable amount of time and physical effort. Traditionally, golfers have had to rely on labor-intensive methods, such as manual scrubbing and polishing, to ensure their equipment is free of dirt, grass stains, and other debris that can affect performance. Additionally, the option of seeking professional cleaning services, while effective, presents its own set of drawbacks. These services can be expensive, and accessing them may not always be convenient, particularly for those with busy schedules or limited access to such resources. Consequently, this situation has left many golfers in a predicament, longing for a more practical and less cumbersome solution. In addition, existing cleaning devices are large and cumbersome.

Therefore, there exists a long-felt need in the art for an improved device for cleaning golf balls and golf clubs. There also exists a long-felt need in the art for an ultrasonic golf club cleaning device. More specifically, there exists a long-felt need in the art for an ultrasonic golf club cleaning device that can be used to quickly and efficiently clean a golf club in an automated manner. There also exists a long-felt need in the art for an ultrasonic golf club cleaning device that can be used to quickly and efficiently clean a golf ball.

The subject matter disclosed and claimed herein, in one embodiment thereof, comprises an ultrasonic golf club cleaning device. The device is comprised of a body with an ultrasonic cleaning element that cleans golf clubs and balls. More specifically, the body includes an interior space to accommodate a pan and/or a basket, the former for clubs and the latter for balls, which can be filled with a cleaning solution to remove dirt when the ultrasonic element is activated. The device is characterized by its adaptability to different shapes and sizes of golf club heads through the angled bottom edge of the pan and the inclusion of clips to secure the clubs in an upright position. Additionally, the device features a battery-powered ultrasonic element that can be heated, offering multiple cleaning modes adjustable via a power button and a mode selection button, and an indicator light for operational status.

In this manner, the ultrasonic golf club cleaning device of the present invention accomplishes all the foregoing objectives and provides an improved device for cleaning golf balls and golf clubs. More specifically, the device can be used to quickly and efficiently clean a golf club and a golf ball using ultrasonic cleaning. Further, the device does so in a compact and easy-to-use device.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an ultrasonic golf club cleaning device. The device is comprised of a body with at least one ultrasonic cleaning element that can be used to clean golf clubs and/or golf balls. The body is comprised of at least one interior space that receives at least one pan that receives the club head of a golf club. The club is further secured via at least one club-receiving member positioned on at least one vertical member of the body that holds the shaft of the club in a generally upright position. In a different embodiment, the interior space receives at least one basket used for receiving and cleaning golf balls.

The body is comprised of at least one ultrasonic cleaning element such that a golf club and/or golf ball can be placed inside the pan and/or basket which is then placed inside the interior space. The interior space and/or pan can then be filled with at least one cleaning solution that removes dirt and debris from the club head and/or golf ball once the cleaning element is activated.

The cleaning element can be powered on/off via at least one power button. The cleaning element may be comprised of a plurality of cleaning modes, each mode of different intensity. The modes can be selected via at least one cleaning mode button. The device may also be comprised of at least one indicator light that illuminates when the cleaning element is powered on.

The present invention is also comprised of a method of using the device. First, a device is provided comprised of a body comprised of an interior space comprised of at least one ultrasonic cleaning element, at least one pan, and at least one club receiving member. Then, the pan can be placed into the interior space and can be filled with a cleaning solution. Next, a club head of a golf club can be placed into the pan and the shaft of the club can be placed within the club receiving member. Finally, the cleaning element can be powered on to remove dirt/debris from the club head through ultrasonic cleaning.

The present invention is also comprised of a second method of using the device. First, a device is provided comprised of a body comprised of an interior space comprised of at least one ultrasonic cleaning element, and at least one basket. Then, the basket can be placed into the interior space and can be filled with a cleaning solution. Next, a golf ball can be placed into the basket. Finally, the cleaning element can be powered on to remove dirt/debris from the ball through ultrasonic cleaning.

Accordingly, the ultrasonic golf club cleaning device of the present invention is particularly advantageous as it provides an improved device for cleaning golf balls and golf clubs. More specifically, the device can be used to quickly and efficiently clean a golf club and a golf ball using ultrasonic cleaning. Further, the device does so in a compact and easy-to-use device. In this manner, the ultrasonic golf club cleaning device overcomes the limitations of existing methods and devices used for cleaning golf balls and golf clubs known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an ultrasonic golf club cleaning device of the present invention with a pan and a basket outside of the interior space of the device in accordance with the disclosed architecture;

FIG. 2 illustrates a perspective view of one potential embodiment of an ultrasonic golf club cleaning device of the present invention while receiving golf clubs in accordance with the disclosed architecture;

FIG. 3 illustrates a perspective view of one potential embodiment of an ultrasonic golf club cleaning device of the present invention in accordance with the disclosed architecture;

FIG. 4 illustrates a side view of one potential embodiment of an ultrasonic golf club cleaning device of the present invention while receiving golf clubs in accordance with the disclosed architecture;

FIG. 5 illustrates a flowchart of a method of using one potential embodiment of an ultrasonic golf club cleaning device of the present invention in accordance with the disclosed architecture; and

FIG. 6 illustrates a flowchart of a method of using one potential embodiment of an ultrasonic golf club cleaning device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved device for cleaning golf balls and golf clubs. There also exists a long-felt need in the art for an ultrasonic golf club cleaning device. More specifically, there exists a long-felt need in the art for an ultrasonic golf club cleaning device that can be used to quickly and efficiently clean a golf club in an automated manner. There also exists a long-felt need in the art for an ultrasonic golf club cleaning device that can be used to quickly and efficiently clean a golf ball.

The present invention, in one exemplary embodiment, is comprised of an ultrasonic golf club cleaning device. The device is comprised of a body with at least one ultrasonic cleaning element that can be used to clean golf clubs and/or golf balls. The body is comprised of at least one interior space that receives at least one pan that receives the club head of a golf club. The club is further secured via at least one club-receiving member positioned on at least one vertical member of the body that holds the shaft of the club in a generally upright position. In a different embodiment, the interior space receives at least one basket used for receiving and cleaning golf balls.

The body is comprised of at least one ultrasonic cleaning element. As a result, a golf club and/or golf ball can be placed inside the pan and/or basket which is then placed inside the interior space. The interior space and/or pan can then be filled with at least one cleaning solution that removes dirt and debris from the club head and/or golf ball once the cleaning element is activated.

The cleaning element can be powered on/off via at least one power button. The cleaning element may be comprised of a plurality of cleaning modes, each mode of different intensity. The modes can be selected via at least one cleaning mode button. The device may also be comprised of at least one indicator light that illuminates when the cleaning element is powered on.

The present invention is also comprised of a method of using the device. First, a device is provided comprised of a body comprised of an interior space comprised of at least one ultrasonic cleaning element, at least one pan, and at least one club receiving member. Then, the pan can be placed into the interior space and can be filled with a cleaning solution. Next, a club head of a golf club can be placed into the pan and the shaft of the club can be placed within the club receiving member. Finally, the cleaning element can be powered on to remove dirt/debris from the club head through ultrasonic cleaning.

The present invention is also comprised of a second method of using the device. First, a device is provided comprised of a body comprised of an interior space comprised of at least one ultrasonic cleaning element, and at least one basket. Then, the basket can be placed into the interior space and can be filled with a cleaning solution. Next, a golf ball can be placed into the basket. Finally, the cleaning element can be powered on to remove dirt/debris from the ball through ultrasonic cleaning.

Accordingly, the ultrasonic golf club cleaning device of the present invention is particularly advantageous as it provides an improved device for cleaning golf balls and golf clubs. More specifically, the device can be used to quickly and efficiently clean a golf club and a golf ball using ultrasonic cleaning. Further, the device does so in a compact and easy-to-use device. In this manner, the ultrasonic golf club cleaning device overcomes the limitations of existing methods and devices used for cleaning golf balls and golf clubs known in the art.

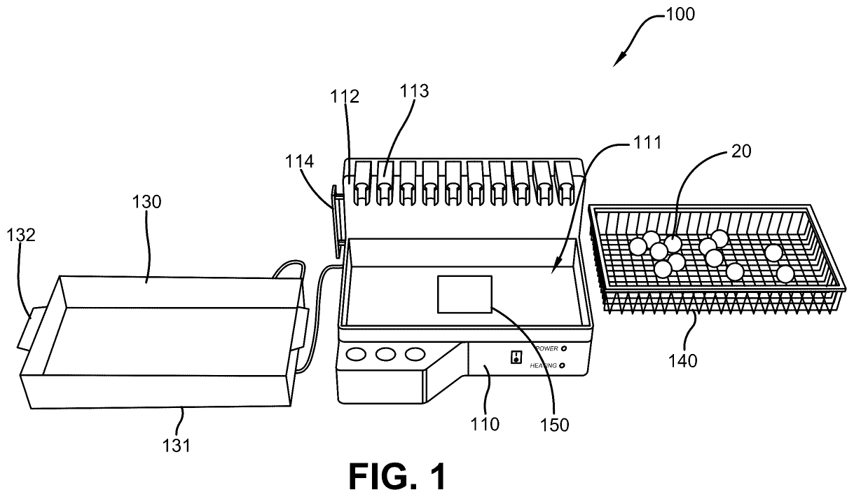

Referring initially to the drawings, FIG. 1 illustrates a perspective view of one potential embodiment of an ultrasonic golf club cleaning device 100 of the present invention with a pan 130 and a basket 140 outside of the interior space 111 of the device in accordance with the disclosed architecture. The device 100 is comprised of a body 110 with at least one ultrasonic cleaning element 150 that can be used to clean golf clubs 10 and/or golf balls 20. The body 110 may be any size, shape, and configuration and may be made from any material type known in the art.

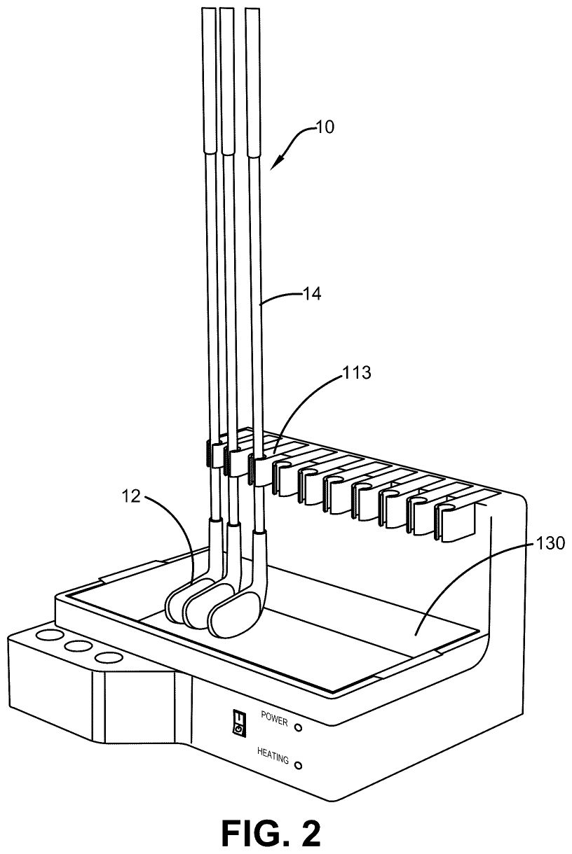

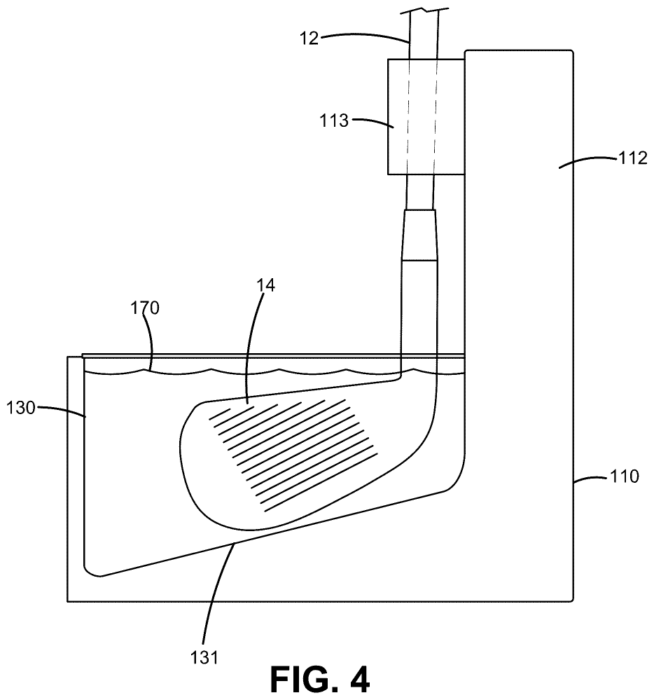

The body 110 is comprised of at least one interior space 111. The interior space 111 receives at least one pan 130. The pan 130 may be made from any material and may be comprised of at least one handle 132 for easy removal from the interior space 111. During use, the pan 130 receives the club head 12 of a golf club 10. More specifically, a bottom edge 131 of the pan 130 may be comprised of an angle (greater than 1 degree, but preferably greater than 90 degrees) that may accept the lie angle of a club head 12, as seen in FIG. 4. The club 10 is further secured via at least one club receiving member 113 positioned on at least one vertical member 112 of the body 110, as seen in FIG. 2. The member 113 is preferably comprised of a clip or other similar fastener that holds the shaft 14 of the club 10 in a generally upright position (preferably between 85 and 95 degrees) and allows a user to place clubs 10 into the member 113 from a standing position via a cantilever effect achieved by an angled bottom edge 131 and flat walls of the pan 130. In a different embodiment, the interior space 110 receives at least one basket 140 that may or may not be placed within the pan 130 (such that the pan catches any debris that falls through the basket 1400. The basket 140 could be used for receiving and cleaning golf balls 20.

The body 110 is comprised of at least one ultrasonic cleaning element 150. The element 150 may be any type of element that can create ultrasonic waves or acoustic waves. The element 150 may include, but is not limited to, a transducer. As a result, a golf club 10 and/or golf ball 20 can be placed inside the pan 130 and/or basket 140 which is then placed inside the interior space 111. The pan 130 preferably receives golf clubs 10 and the basket 140 preferably receives golf balls 20. The interior space 111 and/or pan 130 can then be filled with at least one cleaning solution 170 that removes dirt and debris from the club head 12 and/or golf ball 20 once the cleaning element 150 is activated. The cleaning solution 170 may be any type of cleaning solution known in the art such as, but not limited to, a detergent solution. In one embodiment, the cleaning element 150 may also be heated. The interior of the pan 130, basket 140, and/or interior space 111 may be comprised of at least one fill line 180 that indicates to a user the maximum amount of cleaning solution 170 that should be used/poured into the device 100.

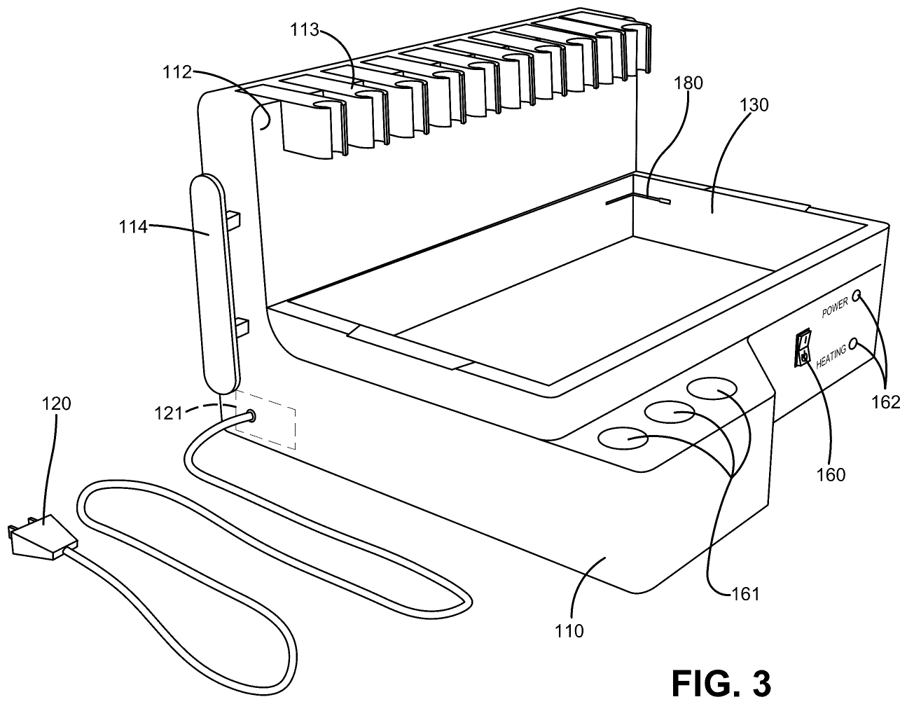

The cleaning element 150 is powered by at least one battery 121. The battery 121 receives power via at least one power cord 120 of any type. In one embodiment, the body 110 is comprised of at least one cord receiving area 114 that the power cord 120 can be stored/wrapped around when not in use, as seen in FIG. 3.

The cleaning element 150 can be powered on/off via at least one power button 160. The cleaning element 150 may also automatically power off when a cleaning cycle is completed. The cleaning element 150 may be comprised of a plurality of cleaning modes, each mode of different intensity. The modes can be selected via at least one cleaning mode button 161. The device 100 may also be comprised of at least one indicator light 162 that illuminates when the cleaning element 150 is powered on.

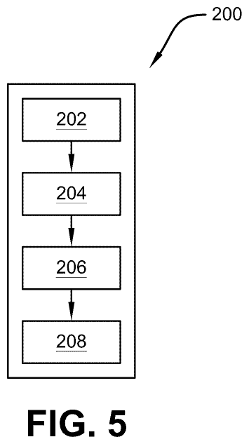

The present invention is also comprised of a method of using 200 the device 100, as seen in FIG. 5. First, a device 100 is provided comprised of a body 110 comprised of an interior space 111 comprised of at least one ultrasonic cleaning element 150, at least one pan 130, and at least one club receiving member 113 [Step 202]. Then, the pan 130 can be placed into the interior space 111 and can be filled with a cleaning solution 170 [Step 204]. Next, a club head 12 of golf club 10 can be placed into the pan 130 and the shaft 14 of the club 10 can be placed within the club receiving member 113 [Step 206]. Finally, the cleaning element 150 can be powered on to remove dirt/debris from the club head 12 through ultrasonic cleaning [Step 208].

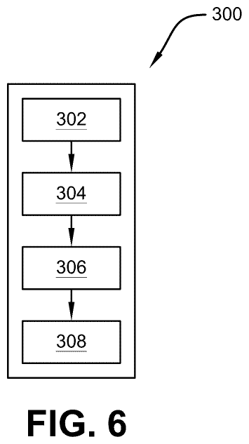

The present invention is also comprised of a second method of using 300 the device 100, as seen in FIG. 6. First, a device 100 is provided comprised of a body 110 comprised of an interior space 111 comprised of at least one ultrasonic cleaning element 150, and at least one basket 140 [Step 302]. Then, the basket 140 can be placed into the interior space 111 and can be filled with a cleaning solution 170 [Step 304]. Next, a golf ball 20 can be placed into the basket 140 [Step 306]. Finally, the cleaning element 150 can be powered on to remove dirt/debris from the ball 20 through ultrasonic cleaning [Step 308].

In summary, the device 100 is designed for efficiently cleaning golf clubs 10 in a compact package that can be easily stored, significantly differing from the bulky, industrial alternatives currently known in the art. Due to the size of the device 100, the device 100 uses minimal water/cleaning solution 170 and space to clean clubs 10 by orienting club heads 12 in an optimal manner that maximizes the use of available volume. Specifically, the device 100 positions clubs in an upright and side by side position, with only the club heads 12 submerged and the shafts gripped near the hosel to minimize the amount of space the device 100 takes up while being usc. The pan 130 is further preferably sized to accommodate the length of the largest iron from heel to toe, ensuring that the clubs are oriented with the toe forward to promote space efficiency. This focus on compactness and efficient orientation not only addresses the issue of excessive space and resource usage found in professional-grade cleaning solutions but also positions this product as an ideal solution for retail consumers seeking a practical, space-saving solution for cleaning golf clubs at home.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ultrasonic golf club cleaning device” and “device” are interchangeable and refer to the ultrasonic golf club cleaning device 100 of the present invention.

Notwithstanding the foregoing, the ultrasonic golf club cleaning device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ultrasonic golf club cleaning device 100 as shown in the FIGS. are for illustrative purposes only, and that many other sizes and shapes of the ultrasonic golf club cleaning device 100 are well within the scope of the present disclosure. Although the dimensions of the ultrasonic golf club cleaning device 100 are important design parameters for user convenience, the ultrasonic golf club cleaning device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ultrasonic golf club cleaning device comprising:
a body comprised of an interior space;
an ultrasonic cleaning element;
a club-receiving member;
a battery; and
a pan.

2. The ultrasonic golf club cleaning device of claim 1, wherein a bottom edge of the pan is comprised of an angle greater than 1 degree.

3. The ultrasonic golf club cleaning device of claim 1, wherein the pan is comprised of a handle.

4. The ultrasonic golf club cleaning device of claim 1, wherein the body is comprised of a vertical member.

5. The ultrasonic golf club cleaning device of claim 4, wherein the club-receiving member is positioned on the vertical member.

6. The ultrasonic golf club cleaning device of claim 1, wherein the ultrasonic cleaning element is comprised of a transducer.

7. The ultrasonic golf club cleaning device of claim 1, wherein the ultrasonic cleaning element is comprised of a heated ultrasonic cleaning element.

8. The ultrasonic golf club cleaning device of claim 1 further comprised of a button.

9. An ultrasonic golf club cleaning device comprising:
a body comprised of an interior space;
an ultrasonic cleaning element;
a club-receiving member;
a battery;
a pan; and
a basket.

10. The ultrasonic golf club cleaning device of claim 9 further comprised of an indicator light.

11. The ultrasonic golf club cleaning device of claim 9, wherein the pan is comprised of a fill line.

12. The ultrasonic golf club cleaning device of claim 9 further comprised of a cleaning solution.

13. The ultrasonic golf club cleaning device of claim 12, wherein the cleaning solution is comprised of a detergent solution.

14. The ultrasonic golf club cleaning device of claim 9, wherein the club-receiving member is comprised of a clip.

15. A method of using an ultrasonic golf club cleaning device, the method comprising the following steps:
providing an ultrasonic golf club cleaning device comprised of a body comprised of an interior space comprised of at least one ultrasonic cleaning element, at least one pan, and at least one club receiving member;
placing the pan into the interior space;
placing a club head of a golf club into the pan and placing a shaft of the golf club into the club receiving member; and
powering on the ultrasonic cleaning element.

16. The method of using an ultrasonic golf club cleaning device of claim 15, wherein the ultrasonic cleaning element is comprised of a transducer.

17. The method of using an ultrasonic golf club cleaning device of claim 15, wherein the ultrasonic golf club cleaning device is comprised of a basket.

18. The method of using an ultrasonic golf club cleaning device of claim 15, wherein the ultrasonic golf club cleaning device is comprised of a cleaning solution.

19. The method of using an ultrasonic golf club cleaning device of claim 15, wherein the ultrasonic golf club cleaning device is comprised of a power cord.

20. The method of using an ultrasonic golf club cleaning device of claim 15, wherein the ultrasonic golf club cleaning device is comprised of a button.
